(19) United States
(12) Patent Application Publication
(10) Pub. No.: US 2023/0124573 A1
(43) Pub. Date: Apr. 20, 2023

(54) VEHICLE ENERGY BUDGET MANAGER

(71) Applicant: Ford Global Technologies, LLC, Dearborn, MI (US)

(72) Inventors: Marin Assaliyski, Dearborn, MI (US); Jeremy Moore, Ypsilanti, MI (US); Wendy Lynn MacLennan, Northville, MI (US); Catherine Bansek, Royal Oak, MI (US)

(21) Appl. No.: 17/505,164

(22) Filed: Oct. 19, 2021

(51) Int. Cl. B60W 20/12; B60W 20/13; G01C 21/34; G01C 21/36

(52) U.S. Cl. CPC B60W 20/12; B60W 20/13; G01C 21/3469; G01C 21/3605

(57) ABSTRACT

A controller, after a cumulative amount of energy consumed by at least one auxiliary load during travel of a vehicle along a route exceeds a predetermined amount of energy allocated for the at least one auxiliary load during travel of the vehicle along the route, reduces the power provided to the at least one auxiliary load from an energy storage arrangement.

### TECHNICAL FIELD

This disclosure relates to the control of vehicles and systems thereof.

### BACKGROUND

An electric vehicle may use stored electrical energy to power an electric machine to move the vehicle and stored electrical energy to power other electrically powered components (air conditioning systems, entertainment systems, etc.) Between charging events, the stored electrical energy for a particular trip is typically finite.

### SUMMARY

A vehicle includes an electric machine, at least one auxiliary load, an energy storage arrangement that provides power to the electric machine and at least one auxiliary load, and a controller. The controller, responsive to a cumulative amount of energy consumed by the at least one auxiliary load during travel of the vehicle along a route exceeding a predetermined amount of energy allocated for the at least one auxiliary load during travel of the vehicle along the route, reduces the power provided to the at least one auxiliary load from the energy storage arrangement. The controller may be further programmed to, responsive to the cumulative amount of energy exceeding the predetermined amount of energy, interrupt the power provided to the at least one auxiliary load from the energy storage arrangement. The at least one auxiliary load may include a first auxiliary load and a second auxiliary load. Reducing the power provided to the at least one auxiliary load may include reducing the power provided to the first auxiliary load but not the second auxiliary load based on priority parameters associated with the first and second auxiliary loads. The controller may be further programmed to receive input defining the priority parameters. The controller may be further programmed to, responsive to the cumulative amount of energy exceeding the predetermined amount of energy, generate a recommendation for a user of the vehicle to reduce use of the at least one auxiliary load. The controller may be further programmed to generate output for display indicative of the cumulative amount of energy and the predetermined amount of energy. The energy storage arrangement may include a traction battery.

A method includes reducing power provided to at least one auxiliary load of a vehicle after a cumulative amount of energy consumed by the at least one auxiliary load during travel of the vehicle along a route exceeds a predetermined amount of energy allocated for the at least one auxiliary load during travel of the vehicle along the route. The method may further include interrupting the power provided to the at least one auxiliary load after the cumulative amount of energy exceeds the predetermined amount of energy. The at least one auxiliary load may include a first auxiliary load and a second auxiliary load. The reducing may include reducing the power provided to the first auxiliary load but not the second auxiliary load based on priority parameters associated with the first and second auxiliary loads. The method may further include receiving input defining the priority parameters. The method may further include generating a recommendation for a user of the vehicle to reduce use of the at least one auxiliary load. The method may further include generating output for display indicative of the cumulative amount of energy and the predetermined amount of energy.

A power system for a vehicle includes a traction battery and a controller. The controller reduces power provided from the traction battery to a first auxiliary load but not power provided from the traction battery to a second auxiliary load based on priority parameters associated with the first and second auxiliary loads after a cumulative amount of energy consumed by the first and second auxiliary loads during travel of the vehicle along a route exceeds a predetermined amount of energy allocated for the first and second auxiliary loads during travel of the vehicle along the route. The controller may be further programmed to interrupt the power provided from the traction battery to the first auxiliary load after the cumulative amount of energy exceeds the predetermined amount of energy. The controller may be further programmed to receive input defining the priority parameters. The controller may be further programmed to generate a recommendation for a user of the vehicle to reduce use of the first or second auxiliary load after the cumulative amount of energy exceeds the predetermined amount of energy. The controller may be further programmed to generate output for display indicative of the cumulative amount of energy and the predetermined amount of energy.

### BRIEF DESCRIPTION OF THE DRAWINGS

FIG. 1 is block diagram of a vehicle.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the FIGURES may be combined with features illustrated in one or more other FIGURES to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Strategies related to the setting, maintaining, and arbitrating available energy in an electrified vehicle over the entirety of a trip including auxiliary loads during the trip and at one or more destinations are considered. A user interface may present a budget that divides usage into a driving/range portion for vehicle movement and an energy portion to address all other activities during the trip and at the destination. The budget manager provides real time monitoring and may suggest changing feature usage, driver behavior, or charging stations as needed based on the budget.

In some situations, range anxiety has been an issue. With added features such as on-board generators, customers may need to address available energy anxiety. Certain applications are trip based and may not encompass a daily or weekly timeframe or include auxiliary loads. Also, it may be difficult for a driver to track different load usages and how each load affects vehicle range and energy utilization. Fleet, tailgating, construction, and autonomous situations are possible examples of where a driver may have concern.

A system may thus be provided that allows a driver to budget energy usage via an interface the permits interaction for input of desired auxiliary load usage. The vehicle may provide estimates of auxiliary load usage based on the destination, environment (e.g., temperature, traffic, etc.), and driver habits. And a driver may be able to prioritize load usage to meet their target range and energy usage.

In one example, a driver inputs several criteria including the date, route, and start time for a trip, designated pauses (e.g., time for loading/unloading, tailgating, onsite work, etc.), a selected energy use template, and an optimization priority (e.g., range priority or load priority). A driver alternatively creates an energy use template by entering information related to whether the vehicle will be operated in two wheel driver or four wheel drive, trailer loading, climate settings, point of preferred operation usage and duration, and other expected energy usages, etc. Controller(s) of the vehicle also periodically obtain real-time environmental parameters such as temperature, route factors (e.g., city versus highway driving), traffic loading, elevation change, geo fencing, etc., and real-time vehicle data (e.g., battery state of charge, current, voltage, etc.) using, for example, conventional sensors and/or communication technology. The input criteria, environmental parameters, and vehicle data are then used by the controller(s) to determine energy usage. An interface displays a menu of auxiliary load items and allows trade-off options for range and auxiliary energy use as driver and vehicle inputs are adjusted and/or change.

The interface may be a vehicle dashboard or console monitor, a phone, a computer, fleet scheduling interface, etc. A range budget and auxiliary budget (for auxiliary loads) may be presented to the driver. Indicia may initially indicate the range budget and auxiliary budget. If air conditioning and idle activities, for example, use more energy than expected, the range budget indicia may be decreased and a message for the driver may recommend the air conditioning be disabled to balance the range and auxiliary budgets. If traction activities user more energy than expected, the auxiliary budget indicia may be decreased and a message for the driver may recommend certain auxiliary loads be disabled to maintain the auxiliary budget, or recommend the driver reduce planned auxiliary-budget-related activities at their destination, etc.

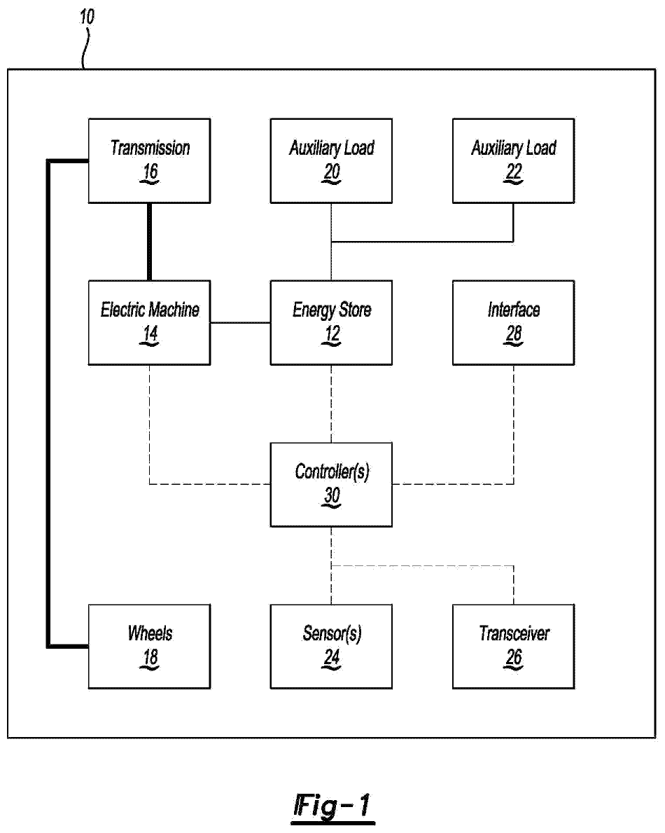

Referring to FIG. 1, a vehicle 10 includes an energy store 12 (e.g., traction battery, ultra-capacitor, etc.), an electric machine 14, transmission 16, wheels 18, auxiliary loads 20, 22 (e.g., entertainment system, heating elements, on-board generator, power tools, etc.), sensor(s) 24 (e.g., current sensors, speed sensors, temperature sensors, voltage sensors, weight sensors, etc.), transceiver 26, interface 28, and controller(s) 30. The electric machine 14 selectively receives electric power from the energy store 12 and transforms it to mechanical power for delivery to the transmission 16 and wheels 18 to move the vehicle 10. The electric machine 14 also selectively receives mechanical power from the wheels 18 and transmission 16 and transforms it to electric power for storage in the energy store 12. The auxiliary loads 20, 22 selectively receive electric power from the energy store 12 for consumption. If the energy store 12 operates at high voltages (e.g., 200 volts to 800 volts), circuitry (not shown) to step down such voltage would be included in the electrical path between the energy store 12 and auxiliary loads 20, 22. The sensor(s) 24 detect various parameter values such as ambient temperature, current flow to the auxiliary loads, current flow to and from the electric machine, voltage of the energy store 12, and other such parameter values. The transceiver 26, among other things, receives signals containing data regarding location of the vehicle 10, elevation, road type, and traffic along a route planned for the vehicle 10, and other such data. The interface 28 displays various information and permits a user to input selections and other data. The controller(s) 30 are in communication with/control the components and systems of FIG. 1. As such, the controller(s) 30 may command the energy store 12 to provide electric power to the electric machine 14, may permit electric power from the energy store 12 to the auxiliary loads 20, 22, may receive the parameter values and data from the sensor(s) 24 and transceiver 26 respectively, and may generate output for display by the interface 28.

The controller(s) 30 may receive input from a user via the interface 28 regarding a trip for the vehicle 10 (e.g., a destination for the vehicle 10 on a particular day and time) and information regarding an identity of the driver and habits of the driver (e.g., driver is aggressive, driver is cautious, etc.). It may also provide via the interface 28 a field for the user to select a priority among the auxiliary loads 20, 22. That is, the user may select whether, if the auxiliary budget is violated, power to the auxiliary load 20 may be reduced/interrupted or power to the auxiliary load 22 may be reduced/interrupted to maintain proper balance between the range and auxiliary budgets. Such selection assigns priority to one of the auxiliary loads 20, 22 over the other. The one with the higher priority may not experience any reduction or interruption in power.

With the destination identified, the controller(s) 30 may generate a route for the vehicle 10 using conventional navigation technologies. The controller(s) 30 may also predetermine the range and auxiliary budgets for the route. The input from the user, and parameter values and data from the sensor(s) 24 and transceiver 26 may be compared (using machine learning or other suitable techniques) against a library of such parameter values and data that correspond with previous cumulative actual energies consumed for range and auxiliary loads along that same route. These previous cumulative actual energies may be defined on a segment-by-segment basis for the route such that the cumulative actual energies consumed for each of range and auxiliary loads is known at the half-way point on the route, the three-quarters-way point on the route, etc. Alternatively, the controller(s) 30 may predetermine the range and auxiliary budgets for the route using other past history data from the vehicle 10 (or other vehicles), calculations, simulations, or any other known and/or suitable technique. The vehicle 10 may “learn” via standard techniques, for example, the amounts of energy consumed by the electric machine 14 and auxiliary loads 20, 22 as the vehicle 10 travels to and from a place of work of the driver over the course of several months, etc.

The controller(s) 30 may use the parameter values from the sensor(s) 24 to track the cumulative amount of energy consumed by the electric machine 14 and auxiliary loads 20, 22 during the trip. The sensors(s) 24, as suggested above, include current sensors arranged in typical fashion to sense current flow to the auxiliary loads 20, 22, and current flow to and from the electric machine 14. The sensor(s) 24, as also suggested above, include similarly situated voltage sensors. The corresponding current and voltage data for given travel times can be used to compute or otherwise determine the cumulative amounts of energy consumed all along the trip. Other sensing techniques are also contemplated.

The controller(s) 30 may generate output to display the predetermined range and auxiliary budgets via the interface 28, and the actual cumulative amounts of energy consumed by the electric machine 14 and auxiliary loads 20, 22. With this data available, the controller(s) 30 may also compare, for each of the range and auxiliary budgets, whether the corresponding actual cumulative amounts exceed the budgets at any point along the route. Responsive to the actual amount exceeding its corresponding budget amount, the controller(s) 30 may take several actions. If, for example, the actual amount of energy consumed by the auxiliary loads 20, 22 exceeds the budgeted amount at the half-way point, the controller(s) 30 may reduce current flow to the one of the auxiliary loads 20, 22 identified as being lower priority in an attempt to balance the budgets. If such reductions are not sufficient to balance the budgets, the controller(s) 30 may interrupt current flow to the one of the auxiliary loads 20, 22 identified as being lower priority. The controller(s) 30 may also generate recommendations for the driver regarding their use of the auxiliary loads and/or modifications to driving behavior in an attempt to balance the budgets.

The suggested feedback to the driver and actions to reduce over-budget energy use may reduce instances of issues experienced by drivers and/or vehicle users with regard to the amount of electrical energy available for use during vehicle use.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of the disclosure.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle comprising:
an electric machine;
at least one auxiliary load;
an energy storage arrangement arranged to provide power to the electric machine and at least one auxiliary load; and
a controller programmed to, responsive to a cumulative amount of energy consumed by the at least one auxiliary load during travel of the vehicle along a route exceeding a predetermined amount of energy allocated for the at least one auxiliary load during travel of the vehicle along the route, reduce the power provided to the at least one auxiliary load from the energy storage arrangement.

2. The vehicle of claim 1, wherein the controller is further programmed to, responsive to the cumulative amount of energy exceeding the predetermined amount of energy, interrupt the power provided to the at least one auxiliary load from the energy storage arrangement.

3. The vehicle of claim 1, wherein the at least one auxiliary load includes a first auxiliary load and a second auxiliary load and wherein reducing the power provided to the at least one auxiliary load includes reducing the power provided to the first auxiliary load but not the second auxiliary load based on priority parameters associated with the first and second auxiliary loads.

4. The vehicle of claim 3, wherein the controller is further programmed to receive input defining the priority parameters.

5. The vehicle of claim 1, wherein the controller is further programmed to, responsive to the cumulative amount of energy exceeding the predetermined amount of energy, generate a recommendation for a user of the vehicle to reduce use of the at least one auxiliary load.

6. The vehicle of claim 1, wherein the controller is further programmed to generate output for display indicative of the cumulative amount of energy and the predetermined amount of energy.

7. The vehicle of claim 1, wherein the energy storage arrangement includes a traction battery.

8. A method comprising:
reducing power provided to at least one auxiliary load of a vehicle after a cumulative amount of energy consumed by the at least one auxiliary load during travel of the vehicle along a route exceeds a predetermined amount of energy allocated for the at least one auxiliary load during travel of the vehicle along the route.

9. The method of claim 8 further comprising interrupting the power provided to the at least one auxiliary load after the cumulative amount of energy exceeds the predetermined amount of energy.

10. The method of claim 8, wherein the at least one auxiliary load includes a first auxiliary load and a second auxiliary load and wherein the reducing includes reducing the power provided to the first auxiliary load but not the second auxiliary load based on priority parameters associated with the first and second auxiliary loads.

11. The method of claim 10 further comprising receiving input defining the priority parameters.

12. The method of claim 8 further comprising generating a recommendation for a user of the vehicle to reduce use of the at least one auxiliary load.

13. The method of claim 8 further comprising generating output for display indicative of the cumulative amount of energy and the predetermined amount of energy.

14. A power system for a vehicle comprising:
a traction battery; and
a controller programmed to reduce power provided from the traction battery to a first auxiliary load but not power provided from the traction battery to a second auxiliary load based on priority parameters associated with the first and second auxiliary loads after a cumulative amount of energy consumed by the first and second auxiliary loads during travel of the vehicle along a route exceeds a predetermined amount of energy allocated for the first and second auxiliary loads during travel of the vehicle along the route.

15. The power system of claim 14, wherein the controller is further programmed to interrupt the power provided from the traction battery to the first auxiliary load after the cumulative amount of energy exceeds the predetermined amount of energy.

16. The power system of claim 14, wherein the controller is further programmed to receive input defining the priority parameters.

17. The power system of claim 14, wherein the controller is further programmed to generate a recommendation for a user of the vehicle to reduce use of the first or second auxiliary load after the cumulative amount of energy exceeds the predetermined amount of energy.

18. The power system of claim 14, wherein the controller is further programmed to generate output for display indicative of the cumulative amount of energy and the predetermined amount of energy.
